(19) United States
(12) Patent Application Publication
(10) Pub. No.: US 2025/0326876 A1
(43) Pub. Date: Oct. 23, 2025

(54) CURABLE COMPOSITION, CURED LAYER MANUFACTURED USING SAME COMPOSITION, COLOR FILTER INCLUDING SAME CURED LAYER, AND DISPLAY DEVICE INCLUDING SAME COLOR FILTER

(71) Applicant: SAMSUNG SDI CO., LTD., Yongin-si, Gyeonggi-do (KR)

(72) Inventors: Yonghee KANG, Suwon-si (KR); Kyunghee KANG, Suwon-si (KR); Jonggi KIM, Suwon-si (KR); Jihyeon YIM, Suwon-si (KR); Hyunsook JANG, Suwon-si (KR); Bumjin LEE, Suwon-si (KR)

(21) Appl. No.: 18/708,807

(22) PCT Filed: Feb. 16, 2023
(86) PCT No.: PCT/KR2023/002253

§ 371 Date: Oct. 15, 2024

(30) Foreign Application Priority Data
Jun. 10, 2022 (KR) 10-2022-0070929

(51) Int. Cl. C08F 222/10; C08F 2/44; C08F 2/50; C08K 3/22; G02B 5/20

(52) U.S. Cl. CPC C08F 222/102; C08F 2/44; C08F 2/50; C08K 3/22; G02B 5/20; C08K 2003/2241

(57) ABSTRACT

Provided are a curable composition, a cured layer manufactured using the curable composition, a color filter including the cured layer, and a display device including the color filter, the curable composition including (A) a quantum dots; and (B) a polymerizable compound, wherein the polymerizable compound includes a product of a thiol-ene reaction between a (meth)acrylate-based monomer and a thiol-based monomer.

### CROSS-REFERENCE TO RELATED APPLICATION

This application is a U.S. National Phase Patent Application of International Application Number PCT/KR2023/002253, filed on Feb. 16, 2023, which claims priority to Korean Patent Application Number 10-2022-0070929, filed on Jun. 10, 2022, the entire content of each of which is incorporated herein by reference.

### TECHNICAL FIELD

This disclosure relates to a curable composition, a cured layer using the composition, a color filter including the cured layer, and a display device including the color filter.

### BACKGROUND ART

In the case of general quantum dots, due to surface characteristics having hydrophobicity, a solvent in which it is dispersed is limited, and thus, it is difficult to introduce into a polar system such as a binder or a curable monomer.

For example, even in the case of a quantum dot ink composition being actively researched, a polarity is relatively low in an initial step and it may be dispersed in a solvent used in a curable composition having a high hydrophobicity. Therefore, because 20 wt % or more of quantum dots are difficult to be included based on the total amount of the composition, it is impossible to increase photoefficiency of the ink over a certain level. Even though the quantum dots are additionally added and dispersed in order to increase photoefficiency, a viscosity exceeds a range capable of ink-jetting and thus processability may not be satisfied.

In order to achieve the viscosity range capable of ink-jetting, a method of lowering an ink solid content by dissolving 50 wt % or more of a solvent based on the total amount of the composition has been used, which also provides a somewhat satisfactory result in terms of viscosity. However, it may be considered to be a satisfactory result in terms of a viscosity, but nozzle drying due to solvent volatilization and nozzle clogging during ink-jetting, and reduction of a single film thickness as time passed after ink-jetting may become worse and it is difficult to control a thickness deviation after curing. Thus, it is difficult to apply it to actual processes.

Therefore, a solvent-free type quantum dot ink that does not include a solvent is the most desirable form to be applied to an actual process. The current technique of applying a quantum dot itself to a solvent type composition is now limited to a certain extent.

As reported so far, since the solvent type composition to be applied to the actual process includes 20 wt % to 25 wt % of non-surface modified quantum dots through ligand substitution and the like based on the total amount of the solvent type composition and thus has a viscosity limit, photoefficiency and an absorption rate are difficult to increase. On the other hand, a method of reducing a content of the quantum dots and increasing a content of a light diffusing agent (scatterer) has been attempted but fails in improving a sedimentation problem or the low photoefficiency.

### DISCLOSURE

### Technical Problem

An embodiment provides a quantum dot-containing curable composition having excellent stability due to excellent quantum dot barrier characteristics.

Another embodiment provides a cured layer manufactured using the curable composition.

Another embodiment provides a color filter including the cured layer.

Another embodiment provides a display device including the color filter.

### Technical Solution

An embodiment provides a curable composition including (A) a quantum dots; and (B) a polymerizable compound, wherein the polymerizable compound includes a product of a thiol-ene reaction between a (meth)acrylate-based monomer and a thiol-based monomer.

The thiol-based monomer may be a dithiol-based monomer.

The thiol-based monomer may be represented by Chemical Formula 1.

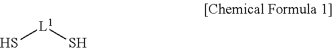

In Chemical Formula 1,
L¹ is an ether linking group (*—O—*), a sulfide linking group (*—S—*), a substituted or unsubstituted C1 to C20 alkylene group, a substituted or unsubstituted C3 to C20 cycloalkylene group, a substituted or unsubstituted C6 to C20 arylene group, or a combination thereof.

Chemical Formula 1 may be represented by Chemical Formula 1-1 or Chemical Formula 1-2.

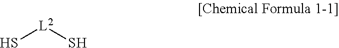

In Chemical Formula 1-1,
L² is a substituted or unsubstituted C1 to C20 alkylene group,

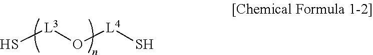

in Chemical Formula 1-2,
L³ and L⁴ are each independently a substituted or unsubstituted C1 to C20 alkylene group, and
n is an integer of 0 to 10.

The (meth)acrylate-based monomer may include a monomer represented by Chemical Formula 2, a monomer represented by Chemical Formula 3, or a mixture thereof.

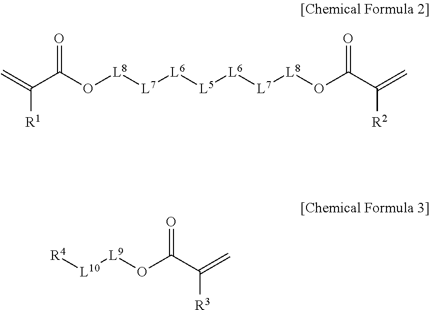

In Chemical Formula 2 and Chemical Formula 3,
R¹ to R⁴ are each independently a hydrogen atom, a substituted or unsubstituted C1 to C20 alkyl group or substituted or unsubstituted C6 to C20 aryl group, and
L⁵ to L¹⁰ are each independently a single bond, an ether linking group (*—O—*), a substituted or unsubstituted C1 to C20 alkylene group, a substituted or unsubstituted C6 to C20 arylene group, a substituted or unsubstituted C3 to C20 cycloalkylene group, a divalent fluorene linking group, or a divalent bicyclic linking group.

The monomer represented by Chemical Formula 2 may be represented by any one of Chemical Formula 2-1 to Chemical Formula 2-4.

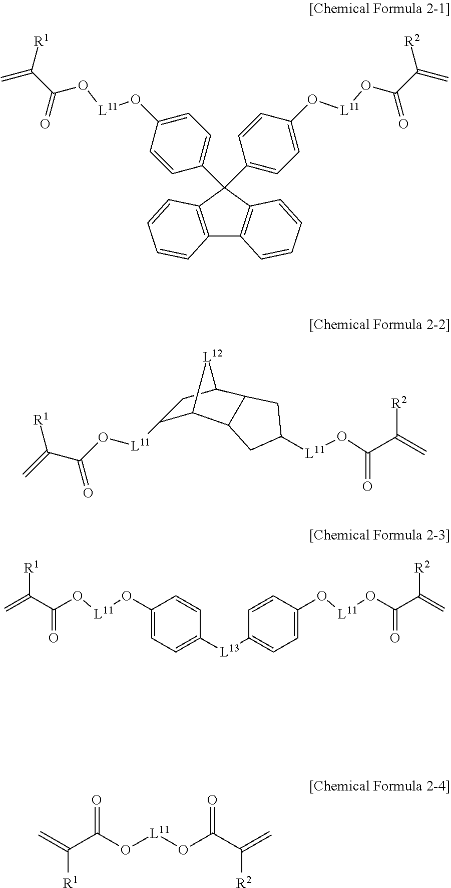

In Chemical Formula 2-1 to Chemical Formula 2-4,
R¹ and R² are each independently a hydrogen atom or a substituted or unsubstituted C1 to C20 alkyl group,
L¹¹ is a substituted or unsubstituted C1 to C20 alkylene group, and L¹² and L¹³ are each independently an ether linking group (*—O—*) or a substituted or unsubstituted C1 to C20 alkylene group.

In Chemical Formula 3, R³ may be a hydrogen atom or a substituted or unsubstituted C1 to C20 alkyl group, R⁴ may be a substituted or unsubstituted C6 to C20 arylene group, and L⁹ and L¹⁰ may each independently be an ether linking group (*—O—*) or a substituted or unsubstituted C1 to C20 alkylene group.

The polymerizable compound may include at least one selected from a monomer represented by Chemical Formula 4 to a monomer represented by Chemical Formula 7.

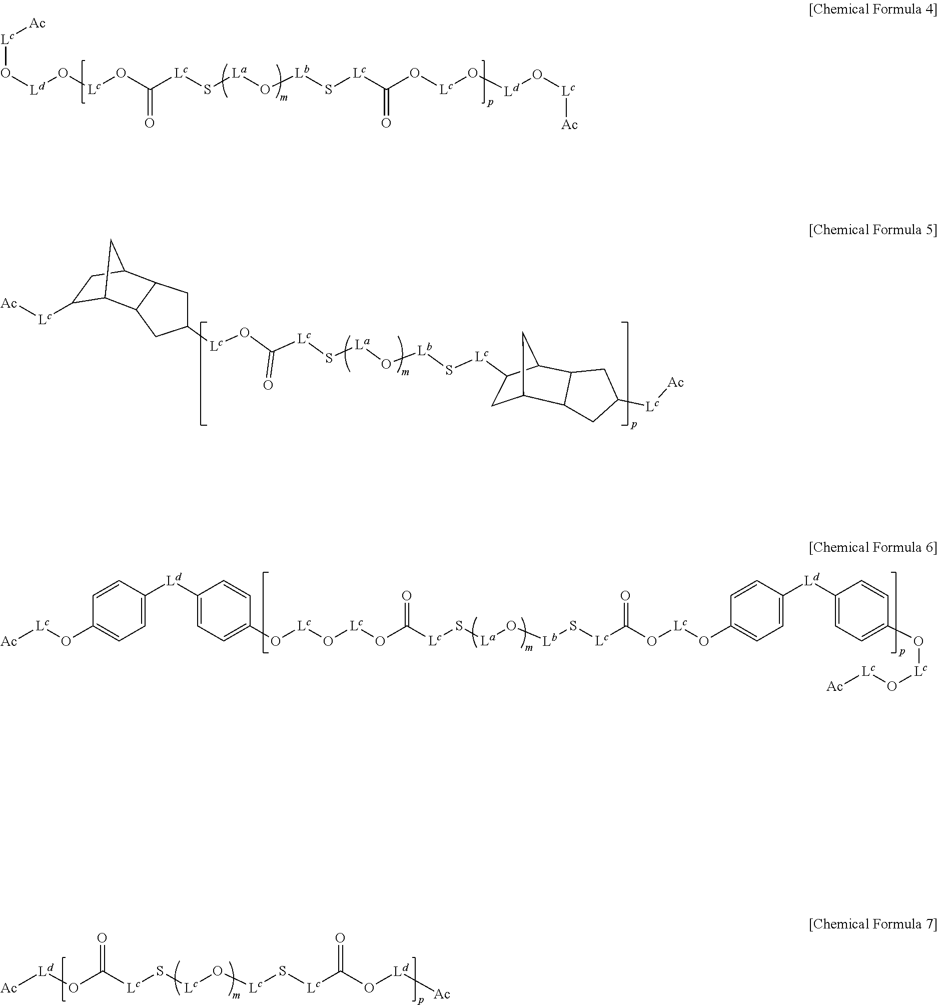

In Chemical Formula 4 to Chemical Formula 7,
Ac is a (meth)acrylate group,
L^{a} to L^{d} are each independently a substituted or unsubstituted C1 to C20 alkylene group,
R^{a} is a substituted or unsubstituted C1 to C20 alkyl group or a substituted or unsubstituted C6 to C20 aryl group,
m is an integer of 0 to 10,
p is an integer of 1 to 100, and
q is an integer of 0 to 5.

The polymerizable compound may further include a monomer represented by Chemical Formula 8 in addition to the product of the thiol-ene reaction between the (meth)acrylate-based monomer and the thiol-based monomer.

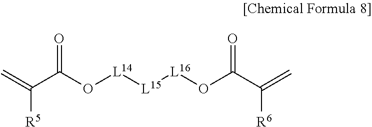

In Chemical Formula 8,
R⁵ and R⁶ are each independently a hydrogen atom or a substituted or unsubstituted C1 to C10 alkyl group,
L¹⁴ and L¹⁶ are each independently a single bond or a substituted or unsubstituted C1 to C10 alkylene group, and
L¹⁵ is a substituted or unsubstituted C1 to C10 alkylene group, a substituted or unsubstituted C3 to C20 cycloalkylene group, or an ether linking group (*—O—*).

The monomer represented by Chemical Formula 8 may be included in an amount greater than the product of the thiol-ene reaction between the (meth)acrylate-based monomer and the thiol-based monomer.

The curable composition may have a viscosity of 500 cps to 1100 cps.

The curable composition may be a solvent-free curable composition.

The solvent-free curable composition may include 5 wt % to 60 wt % of the quantum dots; and 40 wt % to 95 wt % of the polymerizable compound based on the total amount of the solvent-free curable composition.

The curable composition may further include a polymerization initiator, a light diffusing agent, a polymerization inhibitor, or a combination thereof.

The light diffusing agent may include barium sulfate, calcium carbonate, titanium dioxide, zirconia, or a combination thereof.

The curable composition may further include a solvent.

The curable composition may include 1 wt % to 40 wt % of the quantum dots; 1 wt % to 20 wt % of the polymerizable compound; and 40 wt % to 80 wt % of the solvent based on the total amount of the curable composition.

The curable composition may further include malonic acid; 3-amino-1,2-propanediol; a silane-based coupling agent; a leveling agent; a fluorine-based surfactant; or a combination thereof.

Another embodiment provides a cured layer manufactured using the curable composition.

Another embodiment provides a color filter including the cured layer.

Another embodiment provides a display device including the color filter.

Other embodiments of the present invention are included in the following detailed description.

### Advantageous Effects

Through the introduction of a novel oligomer using a thiol-ene reaction, provided is a low-viscosity quantum dot-containing curable composition having excellent dispersibility of quantum dots and capable of forming a matrix well due to a high degree of curing during UV curing.

### BEST MODE

Hereinafter, embodiments of the present invention are described in detail. However, these embodiments are exemplary, the present invention is not limited thereto and the present invention is defined by the scope of claims.

In the present specification, when specific definition is not otherwise provided, “alkyl group” refers to a C1 to C20 alkyl group, “alkenyl group” refers to a C2 to C20 alkenyl group, “cycloalkenyl group” refers to a C3 to C20 cycloalkenyl group, “heterocycloalkenyl group” refers to a C3 to C20 heterocycloalkenyl group, “aryl group” refers to a C6 to C20 aryl group, “arylalkyl group” refers to a C6 to C20 arylalkyl group, “alkylene group” refers to a C1 to C20 alkylene group, “arylene group” refers to a C6 to C20 arylene group, “alkylarylene group” refers to a C6 to C20 alkylarylene group, “heteroarylene group” refers to a C3 to C20 heteroarylene group, and “alkoxylene group” refers to a C1 to C20 alkoxylene group.

In the present specification, when specific definition is not otherwise provided, “substituted” refers to replacement of at least one hydrogen atom by a substituent selected from a halogen atom (F, Cl, Br, or I), a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof.

In the present specification, when specific definition is not otherwise provided, “hetero” refers to inclusion of at least one heteroatom of N, O, S, and P, in the chemical formula.

In the present specification, when specific definition is not otherwise provided, “(meth)acrylate” refers to both “acrylate” and “methacrylate”, and “(meth)acrylic acid” refers to “acrylic acid” and “methacrylic acid”.

In the present specification, when specific definition is not otherwise provided, the term “combination” refers to mixing or copolymerization.

In the present specification, when a definition is not otherwise provided, hydrogen is bonded at the position when a chemical bond is not drawn in chemical formula where supposed to be given.

In addition, in the present specification, when a definition is not otherwise provided, “*” refers to a linking point with the same or different atom or chemical formula.

A quantum dot-containing curable composition according to the present invention includes a product of a thiol-ene reaction between a (meth)acrylate-based monomer and a thiol-based monomer as a polymerizable compound and thus may disperse quantum dots at an equivalent level to or more than a conventional polymerizable compound and also, well form a matrix by UV. Furthermore, since the curable composition according to an embodiment has low viscosity, there is no need to increase a temperature of a nozzle head during the ink jetting and thus no issue such as nozzle clogging, defective shooting, or the like in a head nozzle according to an increase of the temperature.

Hereinafter, each component constituting the curable composition according to an embodiment is described in detail.

### Quantum Dot

The quantum dots included in the curable composition according to an embodiment absorb light in a wavelength region of 360 nm to 780 nm, for example 400 nm to 780 nm and emits fluorescence in a wavelength region of 500 nm to 700 nm, for example 500 nm to 580 nm, or emits fluorescence in a wavelength region of 600 nm to 680 nm. That is, the quantum dots may have a maximum fluorescence emission wavelength (fluorescence λₑₘ) at 500 nm to 680 nm.

The quantum dots may independently have a full width at half maximum (FWHM) of 20 nm to 100 nm, for example 20 nm to 50 nm. When the quantum dots have a full width at half maximum (FWHM) of the ranges, color reproducibility is increased when used as a color material in a color filter due to high color purity.

The quantum dots may independently be an organic material, an inorganic material, or a hybrid (mixture) of an organic material and an inorganic material.

The quantum dots may independently be composed of a core and a shell surrounding the core, and the core and the shell may independently have a structure of a core, a core/shell, a core/first shell/second shell, an alloy, an alloy/shell, or the like, which is composed of Group II-IV, Group III-V, and the like, but are not limited thereto.

For example, the core may include at least one material selected from CdS, CdSe, CdTe, ZnS, ZnSe, ZnTe, HgS, HgSe, HgTe, GaN, GaP, GaAs, InP, InAs, and an alloy thereof, but is not necessarily limited thereto. The shell surrounding the core may include at least one material selected from CdSe, ZnSe, ZnS, ZnTe, CdTe, PbS, TiO, SrSe, HgSe, and an alloy thereof, but is not necessarily limited thereto.

In an embodiment, since an interest in an environment has been recently much increased over the whole world, and a restriction of a toxic material also has been fortified, a cadmium-free light emitting material (InP/ZnS, InP/ZnSe/ZnS, etc.) having little low quantum efficiency (quantum yield) but being environmentally-friendly instead of a light emitting material having a cadmium-based core is used, but not necessarily limited thereto.

In the case of the quantum dots of the core/shell structure, an entire size including the shell (an average particle diameter) may be 1 nm to 15 nm, for example, 5 nm to 15 nm.

For example, the quantum dots may independently include red quantum dots, green quantum dots, or a combination thereof. The red quantum dots may independently have an average particle diameter of 10 nm to 15 nm. The green quantum dots may independently have an average particle diameter of 5 nm to 8 nm.

On the other hand, for the dispersion stability of the quantum dots, the solvent-free curable composition according to an embodiment may further include a dispersant to include the quantum dots in the form of a quantum dot dispersion. The dispersant helps uniform dispersibility of light conversion materials such as quantum dots in the solvent-free curable composition and may include a non-ionic, anionic, or cationic dispersant. Specifically, the dispersant may be polyalkylene glycol or esters thereof, a polyoxy alkylene, a polyhydric alcohol ester alkylene oxide addition product, an alcohol alkylene oxide addition product, a sulfonate ester, a sulfonate salt, a carboxylate ester, a carboxylate salt, an alkyl amide alkylene oxide addition product, an alkyl amine and the like, and they may be used alone or in a mixture of two or more. The dispersant may be used in an amount of 0.1 wt % to 100 wt %, for example 10 wt % to 20 wt % based on the solid content of the light conversion material such as quantum dots.

The quantum dots may be surface-modified with a conventional quantum dot surface-modifying material (e.g., a thiol-based compound, etc.) or may not be surface-modified.

The quantum dots may be included in an amount of 5 wt % to 60 wt %, for example 10 wt % to 60 wt %, for example 20 wt % to 50 wt %, or for example 30 wt % to 50 wt % based on the total amount of the solvent-free curable composition. When the quantum dots (e.g., quantum dot dispersion) are included within the above range, high light retention rate and photoefficiency may be achieved even after curing.

For example, when the curable composition according to an embodiment is a curable composition including a solvent, the quantum dots may be included in 1 wt % to 40 wt %, for example 3 wt % to 30 wt %, based on the total amount of the curable composition. When the quantum dots are included within the above range, the light conversion rate is improved and the pattern characteristics and the developing characteristics are not impaired, and thus excellent processability may be obtained.

### Polymerizable Compound

Currently, quantum dot-containing curable compositions (inks) have been developed in a direction of specializing polymerizable compounds with good compatibility with quantum dots, for example, thiol-based binders or monomers, and some of them have been commercialized.

However, all of the thiol-based monomers developed so far improve only dispersibility of the quantum dots but have a low curing degree during the UV curing, which result in disadvantages in forming a matrix. Accordingly, in order to improve the dispersibility with the monomers, a technique for surface-modifying the quantum dots has been developed, but even though the quantum dots are passivated with a surface-modifying material, the dispersibility of the quantum dots is rather deteriorated, but the improvement of a photocurable rate and a film residue ratio is still unresolved.

Accordingly, the present inventors have solved the aforementioned problem by using an oligomer, which is a product of a thiol-ene reaction between a (meth)acrylate-based monomer and a thiol-based monomer, as a polymerizable compound unlike conventional monomers.

For example, the thiol-based monomer may be a dithiol-based monomer.

For example, the thiol-based monomer may be represented by Chemical Formula 1.

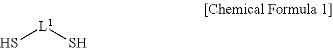

In Chemical Formula 1,
L¹ is an ether linking group (*—O—*), a sulfide linking group (*—S—*), a substituted or unsubstituted C1 to C20 alkylene group, a substituted or unsubstituted C3 to C20 cycloalkylene group, a substituted or unsubstituted C6 to C20 arylene group, or a combination thereof.

For example, Chemical Formula 1 may be represented by Chemical Formula 1-1 or Chemical Formula 1-2.

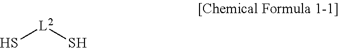

In Chemical Formula 1-1,
L² is a substituted or unsubstituted C1 to C20 alkylene group,

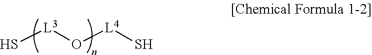

In Chemical Formula 1-2,
L³ and L⁴ are each independently a substituted or unsubstituted C1 to C20 alkylene group, and
n is an integer of 0 to 10.

For example, the (meth)acrylate-based monomer may include a monomer represented by Chemical Formula 2, a monomer represented by Chemical Formula 3, or a mixture thereof, but is not necessarily limited thereto.

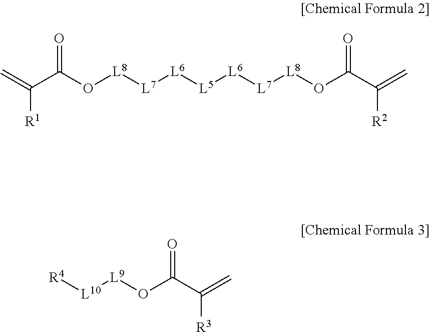

In Chemical Formula 2 and Chemical Formula 3,
R¹ to R⁴ are each independently a hydrogen atom, a substituted or unsubstituted C1 to C20 alkyl group or substituted or unsubstituted C6 to C20 aryl group, and
L⁵ to L¹⁰ are each independently a single bond, an ether linking group (*—O—*), a substituted or unsubstituted C1 to C20 alkylene group, a substituted or unsubstituted C6 to C20 arylene group, a substituted or unsubstituted C3 to C20 cycloalkylene group, a divalent fluorene linking group, or a divalent bicyclic linking group.

The bivalent bicyclic structure may include all of a fused bicyclic structure, a bridged bicyclic structure, and a spiro structure.

For example, the monomer represented by Chemical Formula 2 may be represented by any one of Chemical Formula 2-1 to Chemical Formula 2-4, but is not necessarily limited thereto.

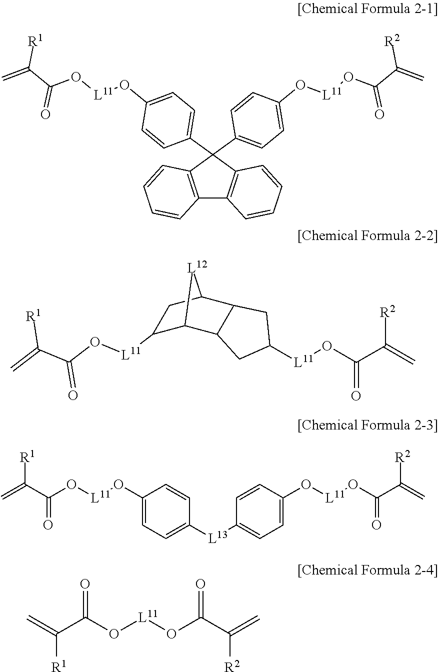

In Chemical Formula 2-1 to Chemical Formula 2-4,
R¹ and R² are each independently a hydrogen atom or a substituted or unsubstituted C1 to C20 alkyl group,
L¹¹ is a substituted or unsubstituted C1 to C20 alkylene group, and
L¹² and L¹³ are each independently an ether linking group (*—O—*) or a substituted or unsubstituted C1 to C20 alkylene group.

For example, in Chemical Formula 3, R³ may be a hydrogen atom or a substituted or unsubstituted C1 to C20 alkyl group, R⁴ may be a substituted or unsubstituted C6 to C20 arylene group, and L⁹ and L¹⁰ may each independently be an ether linking group (*—O—*) or a substituted or unsubstituted C1 to C20 alkylene group.

For example, the polymerizable compound may include at least one selected from a monomer represented by Chemical Formula 4 to a monomer represented by Chemical Formula 7, but is not necessarily limited thereto.

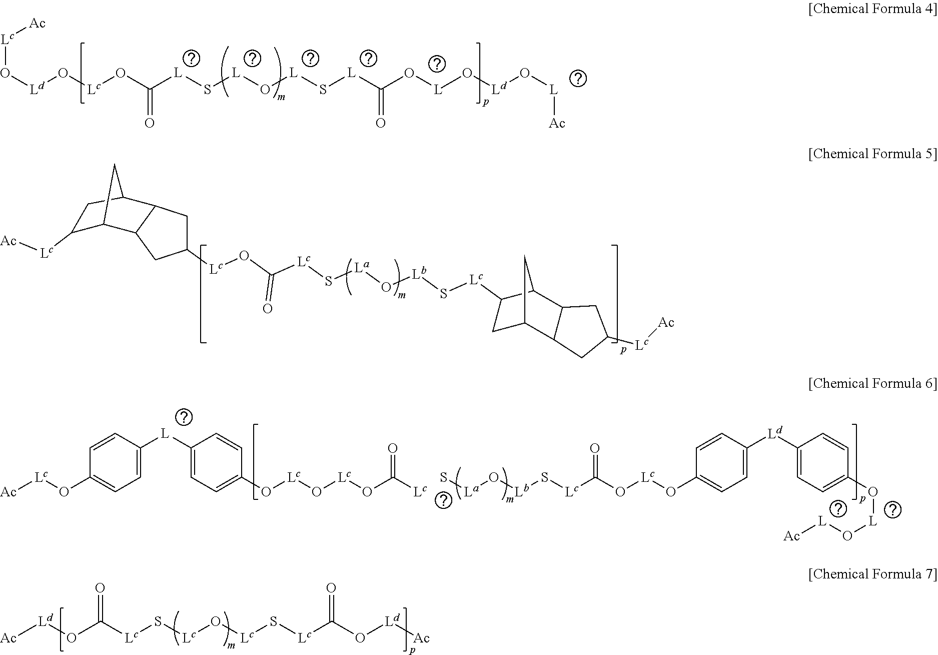

In Chemical Formula 4 to Chemical Formula 7,
Ac is a (meth)acrylate group,
L^{a} to L^{d} are each independently a substituted or unsubstituted C1 to C20 alkylene group,
R^{a} is a substituted or unsubstituted C1 to C20 alkyl group or a substituted or unsubstituted C6 to C20 aryl group,
m is an integer of 0 to 10,
p is an integer of 1 to 100, and
q is an integer of 0 to 5.

In the above chemical formulas, Ac means a (meth)acrylate group, and may be represented by Chemical Formula Ac.

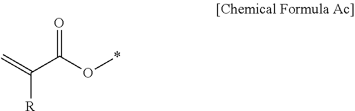

In Chemical Formula Ac, R is a hydrogen atom or a substituted or unsubstituted C1 to C20 alkyl group.

The curable composition according to an embodiment does not use pentaerythritoldiacrylate, pentaerythritoltriacrylate, dipentaerythritoldiacrylate, dipentaerythritoltriacrylate, dipentaerythritolpentaacrylate, pentaerythritolhexaacrylate, bisphenol A diacrylate, trimethylolpropanetriacrylate, novolac epoxyacrylate, and the like alone, which are used for a conventional quantum dot-containing curable composition as a polymerizable compound, but includes a product from a thiol-ene reaction between the (meth)acrylate-based monomer and the thiol-based monomer as a polymerizable compound (or a portion of the polymerizable compound) and thus may increase high dispersibility of the quantum dots as well as have low viscosity, thereby well forming a matrix by UV and exhibiting excellent stability.

For example, when the curable composition according to an embodiment is a solvent-free curable composition, the polymerizable compound may be included in an amount of 40 wt % to 95 wt %, for example 40 wt % to 90 wt %, for example 45 wt % to 85 wt %, or for example 45 wt % to 80 wt % based on the total amount of the solvent-free curable composition. When the polymerizable compound is included within the ranges, the solvent-free curable composition may be prepared to have ink-jettable viscosity, and in addition, quantum dots in the solvent-free curable composition may have excellent dispersibility, also improving optical properties.

For example, the polymerizable compound may further include a monomer represented by Chemical Formula 8 in addition to the product of the thiol-ene reaction between the (meth)acrylate-based monomer and the thiol-based monomer.

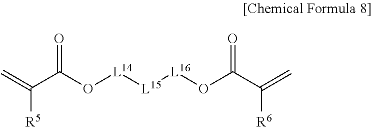

In Chemical Formula 8,
R⁵ and R⁶ are each independently a hydrogen atom or a substituted or unsubstituted C1 to C10 alkyl group,
L¹⁴ and L¹⁶ are each independently a single bond or a substituted or unsubstituted C1 to C10 alkylene group, and
L¹⁵ is a substituted or unsubstituted C1 to C10 alkylene group, a substituted or unsubstituted C3 to C20 cycloalkylene group, or an ether linking group (*—O—*).

For example, the monomer represented by Chemical Formula 8 may have a molecular weight of 170 g/mol to 1,000 g/mol. When the molecular weight of the monomer represented by Chemical Formula 8 is within the above range, it may be advantageous for ink-jetting because a viscosity of the curable composition is not increased without impairing optical properties of the quantum dots.

For example, the monomer represented by Chemical Formula 8 may be represented by Chemical Formula 8-1 or 8-2, but is not limited thereto.

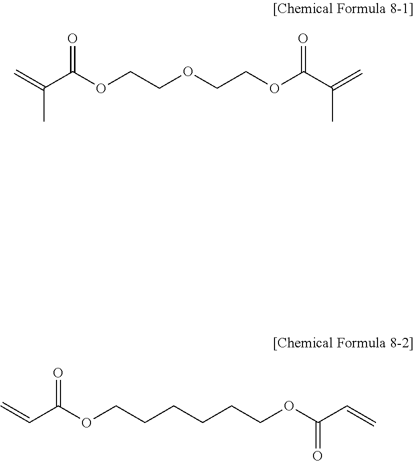

For example, the monomer represented by Chemical Formula 8 may be included in an amount greater than the product of the thiol-ene reaction between the (meth)acrylate-based monomer and the thiol-based monomer. In this case, the curable composition according to the embodiment may better form a matrix during UV curing.

For example, the polymerizable compound may further include ethylene glycoldiacrylate, triethylene glycoldiacrylate, 1,4-butanedioldiacrylate, 1,6-hexanedioldiacrylate, neopentylglycoldiacrylate, pentaerythritoldiacrylate, pentaerythritoltriacrylate, dipentaerythritoldiacrylate, dipentaerythritoltriacrylate, dipentaerythritolpentaacrylate, pentaerythritolhexaacrylate, bisphenol A diacrylate, trimethylolpropanetriacrylate, novolacepoxyacrylate, ethylene glycoldimethacrylate, triethylene glycoldimethacrylate, propylene glycoldimethacrylate, 1,4-butanedioldimethacrylate, 1,6-hexanedioldimethacrylate, or a combination thereof, in addition to the product of the thiol-ene reaction between the (meth)acrylate-based monomer and the thiol-based monomer and the monomer represented by Chemical Formula 8.

In addition, the curable composition according to an embodiment may further include a monomer generally used in conventional thermosetting or photocurable compositions in addition to the polymerizable compound, and for example, the monomer may further include an oxetane-based compound such as bis [1-ethyl (3-oxetanyl)]methyl ether.

For example, when the curable composition according to an embodiment includes a solvent, the polymerizable compound may be included in an amount of 1 wt % to 20 wt %, 1 wt % to 15 wt %, for example 5 wt % to 15 wt %, based on the total amount of the curable composition. When the polymerizable compound is included within the above range, optical properties of the quantum dots may be improved.

### Light Diffusing Agent

The curable composition according to an embodiment may further include a light diffusing agent.

For example, the light diffusing agent may include barium sulfate (BaSO₄), calcium carbonate (CaCO₃), titanium dioxide (TiO₂), zirconia (ZrO₂), or a combination thereof.

The light diffusing agent may reflect unabsorbed light in the aforementioned quantum dots and allows the quantum dots to absorb the reflected light again. That is, the light diffusing agent may increase an amount of light absorbed by the quantum dots and increase light conversion efficiency of the curable composition.

The light diffusing agent may have an average particle diameter (D50) of 150 nm to 250 nm, and specifically 180 nm to 230 nm. When the average particle diameter of the light diffusing agent is within the ranges, it may have a better light diffusing effect and increase light conversion efficiency.

The light diffusing agent may be included in an amount of 1 wt % to 20 wt %, for example 2 wt % to 15 wt %, for example 3 wt % to 10 wt % based on the total amount of the curable composition. When the light diffusing agent is included in less than 1 wt % based on the total amount of the curable composition, it is difficult to expect an effect of improving the light conversion efficiency by using the light diffusing agent, and when it contains more than 20 wt %, the quantum dot sedimentation problem may occur.

### Polymerization Initiator

The curable composition according to an embodiment may further include a polymerization initiator, for example, a photopolymerization initiator, a thermal polymerization initiator, or a combination thereof.

The photopolymerization initiator is a generally-used initiator for a photosensitive resin composition, for example an acetophenone-based compound, a benzophenone-based compound, a thioxanthone-based compound, a benzoin-based compound, a triazine-based compound, an oxime-based compound, an aminoketone-based compound, and the like, but is not necessarily limited thereto.

Examples of the acetophenone-based compound may be 2,2′-diethoxy acetophenone, 2,2′-dibutoxy acetophenone, 2-hydroxy-2-methylpropinophenone, p-t-butyltrichloroacetophenone, p-t-butyldichloroacetophenone, 4-chloroacetophenone, 2,2′-dichloro-4-phenoxy acetophenone, 2-methyl-1-(4-(methylthio)phenyl)-2-morpholinopropan-1-one, 2-benzyl-2-dimethylamino-1-(4-morpholinophenyl)-butan-1-one, and the like.

Examples of the benzophenone-based compound may be benzophenone, benzoyl benzoate, benzoyl methyl benzoate, 4-phenyl benzophenone, hydroxybenzophenone, acrylated benzophenone, 4,4′-bis(dimethyl amino)benzophenone, 4,4′-bis(diethylamino)benzophenone, 4,4′-dimethylaminobenzophenone, 4,4′-dichlorobenzophenone, 3,3′-dimethyl-2-methoxybenzophenone, and the like.

Examples of the thioxanthone-based compound may be thioxanthone, 2-methylthioxanthone, isopropyl thioxanthone, 2,4-diethyl thioxanthone, 2,4-diisopropyl thioxanthone, 2-chlorothioxanthone, and the like.

Examples of the benzoin-based compound may be benzoin, benzoin methyl ether, benzoin ethyl ether, benzoin isopropyl ether, benzoin isobutyl ether, benzyldimethylketal, and the like.

Examples of the triazine-based compound may be 2,4,6-trichloro-s-triazine, 2-phenyl-4,6-bis(trichloromethyl)-s-triazine, 2-(3′,4′-dimethoxystyryl)-4,6-bis(trichloromethyl)-s-triazine, 2-(4′-methoxynaphthyl)-4,6-bis(trichloromethyl)-s-triazine, 2-(p-methoxyphenyl)-4,6-bis(trichloromethyl)-s-triazine, 2-(p-tolyl)-4,6-bis(trichloromethyl)-s-triazine, 2-biphenyl-4,6-bis(trichloromethyl)-s-triazine, bis(trichloromethyl)-6-styryl-s-triazine, 2-(naphthol-yl)-4,6-bis(trichloromethyl)-s-triazine, 2-(4-methoxynaphthol-yl)-4,6-bis(trichloromethyl)-s-triazine, 2-4-bis(trichloromethyl)-6-piperonyl-s-triazine, 2-4-bis(trichloromethyl)-6-(4-methoxystyryl)-s-triazine, and the like.

Examples of the oxime-based compound may be O-acyloxime-based compound, 2-(O-benzoyloxime)-1-[4-(phenylthio)phenyl]-1,2-octandione, 1-(O-acetyloxime)-1-[9-ethyl-6-(2-methylbenzoyl)-9H-carbazol-3-yl]ethanone, O-ethoxycarbonyl-α-oxyamino-1-phenylpropan-1-one, and the like. Specific examples of the O-acyloxime-based compound may be 1,2-octandione, 2-dimethylamino-2-(4-methylbenzyl)-1-(4-morpholin-4-yl-phenyl)-butan-1-one, 1-(4-phenylsulfanyl phenyl)-butane-1,2-dione-2-oxime-O-benzoate, 1-(4-phenylsulfanyl phenyl)-octane-1,2-dione-2-oxime-O-benzoate, 1-(4-phenylsulfanyl phenyl)-octan-1-oneoxime-O-acetate, 1-(4-phenylsulfanyl phenyl)-butan-1-oneoxime-O-acetate, and the like.

Examples of the aminoketone-based compound may be 2-benzyl-2-dimethylamino-1-(4-morpholinophenyl)-butanone-1, and the like.

The photopolymerization initiator may further include a carbazole-based compound, a diketone-based compound, a sulfonium borate-based compound, a diazo-based compound, an imidazole-based compound, a biimidazole-based compound, and the like, besides the compounds.

The photopolymerization initiator may be used with a photosensitizer capable of causing a chemical reaction by absorbing light and becoming excited and then, transferring its energy.

Examples of the photosensitizer may be tetraethylene glycol bis-3-mercapto propionate, pentaerythritol tetrakis-3-mercapto propionate, dipentaerythritol tetrakis-3-mercapto propionate, and the like.

Examples of the thermal polymerization initiator may be peroxide, specifically benzoyl peroxide, dibenzoyl peroxide, lauryl peroxide, dilauryl peroxide, di-tert-butyl peroxide, cyclohexane peroxide, methyl ethyl ketone peroxide, hydroperoxide (e.g., tert-butyl hydroperoxide, cumene hydroperoxide), dicyclohexyl peroxydicarbonate, 2,2-azo-bis(isobutyronitrile), t-butyl perbenzoate, and the like, for example 2,2′-azobis-2-methylpropionitrile, but are not necessarily limited thereto, and any of which is well known in the art may be used.

The polymerization initiator may be included in an amount of 0.1 wt % to 5 wt %, for example 1 wt % to 4 wt % based on the total amount of the curable composition. When the polymerization initiator is included in the ranges, it is possible to obtain excellent reliability due to sufficient curing during exposure or thermal curing and to prevent deterioration of transmittance due to non-reaction initiators, thereby preventing deterioration of optical properties of the quantum dots.

### Binder Resin

The curable composition according to an embodiment may further include a binder resin.

The binder resin may include an acryl-based resin, a cardo-based resin, an epoxy resin, or a combination thereof.

The acryl-based resin may be a copolymer of a first ethylenic unsaturated monomer and a second ethylenic unsaturated monomer that is copolymerizable therewith, and may be a resin including at least one acryl-based repeating unit.

Specific examples of the acryl-based binder resin may be polybenzylmethacrylate, a (meth)acrylic acid/benzylmethacrylate copolymer, a (meth)acrylic acid/benzylmethacrylate/styrene copolymer, a (meth)acrylic acid/benzylmethacrylate/2-hydroxyethylmethacrylate copolymer, a (meth)acrylic acid/benzylmethacrylate/styrene/2-hydroxyethylmethacrylate copolymer, and the like, but are not limited thereto, and may be used alone or as a mixture of two or more.

A weight average molecular weight (Mw) of the acryl-based binder resin may be 5,000 g/mol to 15,000 g/mol. When the acryl-based binder resin has a weight average molecular weight within the ranges, close-contacting properties to a substrate, physical and chemical properties are improved, and a viscosity is appropriate.

The acryl-based resin may have an acid value of 80 mgKOH/g to 130 mgKOH/g. When the acryl-based resin has an acid value within the range, a pixel pattern may have excellent resolution.

The cardo-based resin may be used in a conventional curable resin (or photosensitive resin) composition, and may be, for example, used as disclosed in Korean Patent Application Laid-Open No. 10-2018-0067243, but is not limited thereto.

The cardo-based resin may be, for example prepared by mixing at least two of a fluorene-containing compound such as 9,9-bis(4-oxiranylmethoxyphenyl) fluorene; an anhydride compound such as benzenetetracarboxylic acid dianhydride, naphthalenetetracarboxylic acid dianhydride, biphenyltetracarboxylic acid dianhydride, benzophenonetetracarboxylic acid dianhydride, pyromellitic dianhydride, cyclobutanetetracarboxylic acid dianhydride, perylenetetracarboxylic acid dianhydride, tetrahydrofurantetracarboxylic acid dianhydride, and tetrahydrophthalic anhydride; a glycol compound such as ethylene glycol, propylene glycol, and polyethylene glycol; an alcohol compound such as methanol, ethanol, propanol, n-butanol, cyclohexanol, and benzylalcohol; a solvent-based compound such as propylene glycol methylethylacetate, and N-methylpyrrolidone; a phosphorus compound such as triphenylphosphine; and an amine or ammonium salt compound such as tetramethylammonium chloride, tetraethylammonium bromide, benzyldiethylamine, triethylamine, tributylamine, or benzyltriethylammonium chloride.

A weight average molecular weight of the cardo-based binder resin may be 500 g/mol to 50,000 g/mol, for example 1,000 g/mol to 30,000 g/mol. When the weight average molecular weight of the cardo-based binder resin is within the ranges, a satisfactory pattern may be formed without a residue during a production of a cured layer and without losing a film thickness during development of the solvent type curable composition.

When the binder resin is a cardo-based resin, the developability of the curable composition, particularly the photosensitive resin composition, including the binder resin is improved, and the sensitivity during photocuring is good, so that the fine pattern formation property is improved.

The epoxy resin may be a monomer or oligomer that is capable of being polymerized by heat, and may include a compound having a carbon-carbon unsaturated bond and a carbon-carbon cyclic bond.

The epoxy resin may include, but is not limited to, a bisphenol A-type epoxy resin, a bisphenol F-type epoxy resin, a phenol novolac-type epoxy resin, a cyclic aliphatic epoxy resin, and an aliphatic polyglycidyl ether.

Currently available products thereof may include bisphenol epoxy resins such as YX4000, YX4000H, YL6121H, YL6640, or YL6677 from Yuka Shell Epoxy Co., Ltd.; cresol novolac-type epoxy resins such as EOCN-102, EOCN-103S, EOCN-104S, EOCN-1020, EOCN-1025, and EOCN-1027 from Nippon Kayaku Co., Ltd. and EPIKOTE 180S75 from Yuka Shell Epoxy Co., Ltd.; bisphenol A epoxy resins such as EPIKOTE 1001, 1002, 1003, 1004, 1007, 1009, 1010, and 828 from Yuka Shell Epoxy Co., Ltd.; bisphenol F-type epoxy resins such as EPIKOTE 807 and 834 from Yuka Shell Epoxy Co., Ltd.; phenol novolac-type epoxy resins such as EPIKOTE 152, 154, and 157H65 from Yuka Shell Epoxy Co., Ltd. and EPPN 201, 202 from Nippon Kayaku Co., Ltd.; other cyclic aliphatic epoxy resins such as CY175, CY177 and CY179 from CIBA-GEIGY A.G. ERL-4234, ERL-4299, ERL-4221, and ERL-4206 from U.C.C, Shodyne 509 from Showa Denko K.K., ARALDITE CY-182, CY-192 and CY-184 from CIBA-GEIGY A.G, Epichron 200 and 400 from Dainippon Ink and Chemicals, Inc., EPIKOTE 871, 872 and EP1032H60 from Yuka Shell Epoxy Co., Ltd., ED-5661 and ED-5662 from Celanese Coatings Co., Ltd.; aliphatic polyglycidylethers such as EPIKOTE 190P and 191P from Yuka Shell Epoxy Co., Ltd., Epolite 100MF from Kyoesha Yushi Co., Ltd., Epiol TMP from Nippon Yushi Co., Ltd., and the like.

For example, when the curable composition according to an embodiment is a solvent-free curable composition, the binder resin may be included in an amount of 0.5 wt % to 10 wt %, for example 1 wt % to 5 wt %, based on the total amount of the solvent-free curable composition. In this case, heat resistance and chemical resistance of the solvent-free curable composition may be improved, and storage stability of the composition may also be improved.

For example, when the curable composition according to an embodiment is a curable composition including a solvent, the binder resin may be included in an amount of 1 wt % to 30 wt %, for example 3 wt % to 20 wt %, based on the total amount of the curable composition. In this case, pattern characteristics, heat resistance and chemical resistance may be improved.

### Other Additives

For stability and dispersion improvement of the quantum dots, the curable composition according to an embodiment may further include a polymerization inhibitor.

The polymerization inhibitor may include a hydroquinone-based compound, a catechol-based compound, or a combination thereof, but is not necessarily limited thereto. When the curable composition according to an embodiment further includes the hydroquinone-based compound, the catechol-based compound, or the combination thereof, room temperature cross-linking during exposure after printing (coating) the curable composition may be prevented.

For example, the hydroquinone-based compound, catechol-based compound or a combination thereof may include hydroquinone, methyl hydroquinone, methoxyhydroquinone, t-butyl hydroquinone, 2,5-di-t-butyl hydroquinone, 2,5-bis(1,1-dimethylbutyl) hydroquinone, 2,5-bis(1,1,3,3-tetramethylbutyl) hydroquinone, catechol, t-butyl catechol, 4-methoxyphenol, pyrogallol, 2,6-di-t-butyl-4-methylphenol, 2-naphthol, tris(N-hydroxy-N-nitrosophenylaminato-O,O′) aluminium, or a combination thereof, but is not necessarily limited thereto.

The hydroquinone-based compound, catechol-based compound, or a combination thereof may be used in the form of a dispersion, and the polymerization inhibitor in the dispersion form may be included in an amount of 0.001 wt % to 3 wt %, for example 0.01 wt % to 2 wt % based on the total amount of the curable composition. When the polymerization inhibitor is included within the above range, the problem of aging at room temperature may be solved, and at the same time, reduction of sensitivity and surface peeling may be prevented.

In addition, the curable composition according to an embodiment may further include malonic acid; 3-amino-1,2-propanediol; a silane-based coupling agent; a leveling agent; a fluorine-based surfactant; or a combination thereof in order to improve heat resistance and reliability.

For example, the curable composition according to an embodiment may further include a silane-based coupling agent having a reactive substituent such as a vinyl group, a carboxyl group, a methacryloxy group, an isocyanate group, an epoxy group, and the like in order to improve close-contacting properties with a substrate.

Examples of the silane-based coupling agent may be trimethoxysilyl benzoic acid, γ-methacryl oxypropyl trimethoxysilane, vinyl triacetoxysilane, vinyl trimethoxysilane, γ-isocyanate propyl triethoxysilane, γ-glycidoxy propyl trimethoxysilane, β-(epoxycyclohexyl)ethyl trimethoxy silane, and the like, and these may be used alone or in a mixture of two or more.

The silane-based coupling agent may be included in an amount of 0.01 parts by weight to 10 parts by weight based on 100 parts by weight of the curable composition. When the silane-based coupling agent is included within the range, close-contacting properties, storage capability, and the like are improved.

In addition, the curable composition may further include a surfactant, for example a fluorine-based surfactant as needed in order to improve coating properties and inhibit generation of spots, that is, improve leveling performance.

The fluorine-based surfactant may have a low weight average molecular weight of 4,000 g/mol to 10,000 g/mol, and specifically 6,000 g/mol to 10,000 g/mol. In addition, the fluorine-based surfactant may have a surface tension of 18 mN/m to 23 mN/m (measured in 0.1% polyethylene glycol monomethylether acetate (PGMEA) solution). When the fluorine-based surfactant has a weight average molecular weight and a surface tension within the ranges, leveling performance may be further improved, and excellent characteristics may be provided when slit coating as high-speed coating is applied since film defects may be less generated by preventing a spot generation during the high speed coating and suppressing a vapor generation.

Examples of the fluorine-based surfactant may be, BM-1000®, and BM-1100® (BM Chemie Inc.); MEGAFACE F 142DR, F 172°, F 173€, and F 183® Dainippon Ink Kagaku Kogyo Co., Ltd.); FULORAD FC-135®, FULORAD FC-170C®, FULORAD FC-430®, and FULORAD FC-431® (Sumitomo 3M Co., Ltd.); SURFLON S-112®, SURFLON S-113®, SURFLON S-131®, SURFLON S-141°, and SURFLON S-145® (ASAHI Glass Co., Ltd.); and SH-28PAR, SH-190®, SH-193ª, SZ-6032®, and SF-8428®, and the like (Toray Silicone Co., Ltd.); F-482, F-484, F-478, F-554 and the like from DIC Co., Ltd.

In addition, the curable composition according to an embodiment may include a silicone-based surfactant in addition to the fluorine-based surfactant. Specific examples of the silicone-based surfactant may be TSF400, TSF401, TSF410, TSF4440, and the like of Toshiba Silicone Co., Ltd., but is not limited thereto.

The surfactant may be included in an amount of 0.01 parts by weight to 5 parts by weight, for example 0.1 parts by weight to 2 parts by weight based on 100 parts by weight of the curable composition. When the surfactant is included within the ranges, foreign materials are less produced in a sprayed composition.

In addition, the curable composition according to an embodiment may further include other additives such as an antioxidant, a stabilizer, and the like in a predetermined amount, unless properties are deteriorated.

### Solvent

Meanwhile, the curable composition according to an embodiment may further include a solvent.

The solvent may for example include alcohols such as methanol, ethanol, and the like; glycol ethers such as ethylene glycol methylether, ethylene glycol ethylether, propylene glycol methylether, and the like; cellosolve acetates such as methyl cellosolve acetate, ethyl cellosolve acetate, diethyl cellosolve acetate, and the like; carbitols such as methylethyl carbitol, diethyl carbitol, diethylene glycol monomethylether, diethylene glycol monoethylether, diethylene glycol dimethylether, diethylene glycol methylethylether, diethylene glycol diethylether, and the like; propylene glycol alkylether acetates such as propylene glycol monomethylether acetate, propylene glycol propylether acetate, and the like; ketones such as methylethylketone, cyclohexanone, 4-hydroxy-4-methyl-2-pentanone, methyl-n-propylketone, methyl-n-butylketone, methyl-n-amylketone, 2-heptanone, and the like; saturated aliphatic monocarboxylic acid alkyl esters such as ethyl acetate, n-butyl acetate, isobutyl acetate, and the like; lactate esters such as methyl lactate, ethyl lactate, and the like; hydroxy acetic acid alkyl esters such as methyl hydroxyacetate, ethyl hydroxyacetate, butyl hydroxyacetate, and the like; acetic acid alkoxyalkyl esters such as methoxymethyl acetate, methoxyethyl acetate, methoxybutyl acetate, ethoxymethyl acetate, ethoxyethyl acetate, and the like; 3-hydroxypropionic acid alkyl esters such as methyl 3-hydroxypropionate, ethyl 3-hydroxypropionate, and the like; 3-alkoxypropionic acid alkyl esters such as methyl 3-methoxypropionate, ethyl 3-methoxypropionate, ethyl 3-ethoxypropionate, methyl 3-ethoxypropionate, and the like; 2-hydroxypropionic acid alkyl ester such as methyl 2-hydroxypropionate, ethyl 2-hydroxypropionate, propyl 2-hydroxypropionate, and the like; 2-alkoxypropionic acid alkyl esters such as methyl 2-methoxypropionate, ethyl 2-methoxypropionate, ethyl 2-ethoxypropionate, methyl 2-ethoxypropionate, and the like; 2-hydroxy-2-methylpropionic acid alkyl esters such as methyl 2-hydroxy-2-methylpropionate, ethyl 2-hydroxy-2-methylpropionate, and the like; 2-alkoxy-2-methylpropionic acid alkyl esters such as methyl 2-methoxy-2-methylpropionate, ethyl 2-ethoxy-2-methylpropionate, and the like; esters such as 2-hydroxyethyl propionate, 2-hydroxy-2-methylethyl propionate, hydroxyethyl acetate, methyl 2-hydroxy-3-methylbutanoate, and the like; or ketonate esters such as ethyl pyruvate, and the like, and in addition, may be N-methylformamide, N,N-dimethyl formamide, N-methylformanilide, N-methylacetamide, N, N-dimethyl acetamide, N-methylpyrrolidone, dimethylsulfoxide, benzylethylether, dihexylether, acetylacetone, isophorone, caproic acid, caprylic acid, 1-octanol, 1-nonanol, benzyl alcohol, benzyl acetate, ethyl benzoate, diethyl oxalate, diethyl maleate, γ-butyrolactone, ethylene carbonate, propylene carbonate, phenyl cellosolve acetate, and the like, but is not limited thereto.

For example, the solvent may be desirably glycol ethers such as ethylene glycol monoethylether, ethylene diglycolmethylethylether, and the like; ethylene glycol alkylether acetates such as ethyl cellosolve acetate, and the like; esters such as 2-hydroxy ethyl propionate, and the like; carbitols such as diethylene glycol monomethylether, and the like; propylene glycol alkylether acetates such as propylene glycol monomethylether acetate, propylene glycol propylether acetate, and the like; alcohols such as ethanol, and the like, or a combination thereof.

For example, the solvent may be a polar solvent including propylene glycol monomethylether acetate, dipropylene glycol methylether acetate, ethanol, ethylene glycoldimethylether, ethylenediglycolmethylethylether, diethylene glycoldimethylether, 2-butoxyethanol, N-methylpyrrolidine, N-ethylpyrrolidine, propylene carbonate, γ-butyrolactone, or a combination thereof.

The solvent may be included in an amount of 40 wt % to 80 wt %, for example 45 wt % to 80 wt % based on the total amount of the curable composition. When the solvent is within the range, the solvent type curable composition has appropriate viscosity and thus may have excellent coating property when coated in a large area through spin-coating and slit-coating.

Another embodiment provides a cured layer manufactured using the aforementioned curable composition, a color filter including the cured layer, and a display device including the color filter.

One of methods of manufacturing the cured layer may include coating the curable composition on a substrate using an ink-jet spraying method to form a pattern (S1); and curing the pattern (S2).

### (S1) Formation of Pattern

The curable composition may desirably be coated to be 0.5 μm to 20 μm on a substrate in an ink-jet spraying method. The ink-jet spraying method may form a pattern by spraying a single color per each nozzle and thus repeating the spraying as many times as the needed number of colors, but the pattern may be formed by simultaneously spraying the needed number of colors through each ink-jet nozzle in order to reduce processes.

### (S2) Curing

The obtained pattern is cured to obtain a pixel. Herein, the curing method may be thermal curing or photocuring process. The thermal curing process may be performed at greater than or equal to 100° C., desirably, in a range of 100° C. to 300° C., and more desirably, in a range of 160° C. to 250° C. The photocuring process may include irradiating an actinic ray such as a UV ray of 190 nm to 450 nm, for example 200 nm to 500 nm. The irradiating is performed by using a light source such as a mercury lamp with a low pressure, a high pressure, or an ultrahigh pressure, a metal halide lamp, an argon gas laser, and the like. An X ray, an electron beam, and the like may be also used as needed.

The other method of manufacturing the cured layer may include manufacturing a cured layer using the aforementioned curable composition by a lithographic method as follows.

### (1) Coating and Film Formation

The curable composition is coated to have a desired thickness, for example, a thickness ranging from about 2 μm to about 10 μm, on a substrate which undergoes a predetermined pretreatment, using a spin or slit coating method, a roll coating method, a screen-printing method, an applicator method, and the like. Then, the coated substrate is heated at a temperature of about 70° C. to about 90° C. for about 1 minute to about 10 minutes to remove a solvent and to form a film.

### (2) Exposure

The resultant film is irradiated by an actinic ray such as a UV ray of 190 nm to 450 nm, for example 200 nm to 500 nm after putting a mask with a predetermined shape to form a desired pattern. The irradiating is performed by using a light source such as a mercury lamp with a low pressure, a high pressure, or an ultrahigh pressure, a metal halide lamp, an argon gas laser, and the like. An X ray, an electron beam, and the like may be also used as needed. Exposure process uses, for example, a light dose of 500 mJ/cm² or less (with a 365 nm sensor) when a high pressure mercury lamp is used. However, the light dose may vary depending on types of each component of the curable composition, its combination ratio, and a dry film thickness.

### (3) Development

After the exposure process, an alkali aqueous solution is used to develop the exposed film by dissolving and removing an unnecessary part except the exposed part, forming an image pattern. In other words, when the alkali developing solution is used for the development, a non-exposed region is dissolved, and an image color filter pattern is formed.

### (4) Post-Treatment

The developed image pattern may be heated again or irradiated by an actinic ray and the like for curing, in order to accomplish excellent quality in terms of heat resistance, light resistance, close-contacting properties, crack-resistance, chemical resistance, high strength, storage stability, and the like.

### MODE FOR INVENTION

Hereinafter, the present invention is illustrated in more detail with reference to examples. These examples, however, are not in any sense to be interpreted as limiting the scope of the invention.

### Synthesis of Polymerizable Compounds

### Synthesis Example 1: Synthesis of Compound Represented by Chemical Formula A

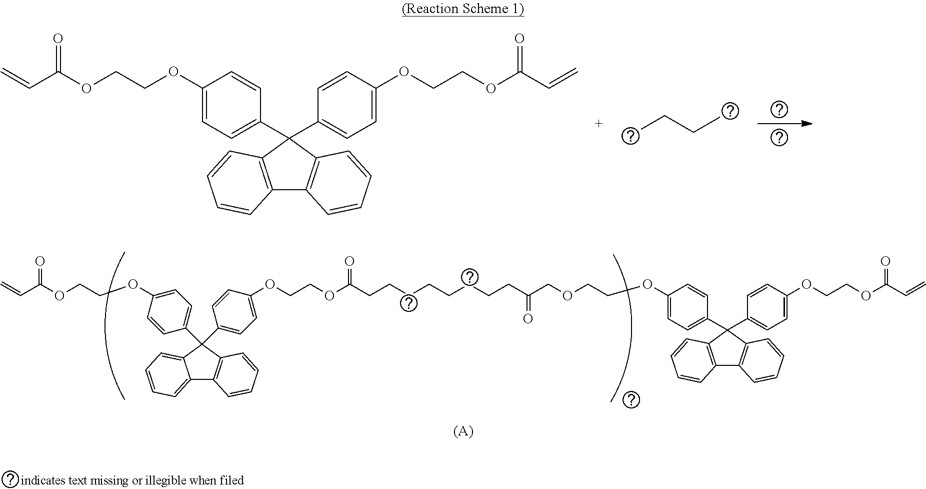

546 g of ethoxylated bisphenyl fluorene diacrylate was dissolved in 500 ml of THF, and 2 g of triethylamine was added thereto. 45 g of 1,2-ethanedithiol was slowly added thereto and then, heated to 60° C., obtaining a compound represented by Chemical Formula A (Mw=1148).

### Synthesis Example 2: Synthesis of Compound Represented by Chemical Formula B

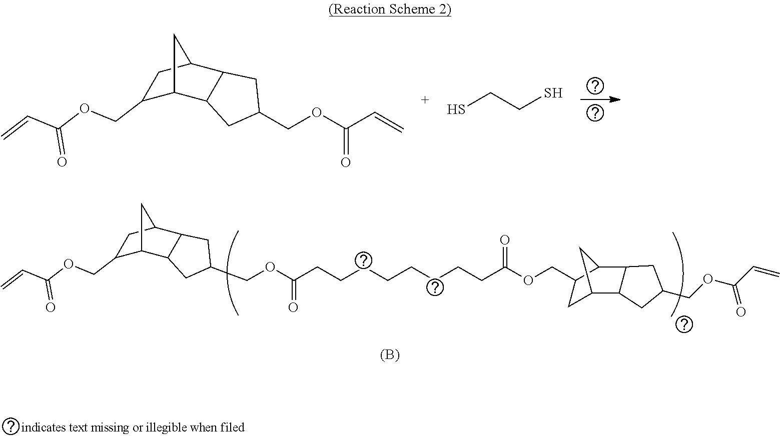

A compound represented by Chemical Formula (B) (Mw=887) was obtained in the same manner as in Synthesis Example 1 except that 304 g of tricyclodecane dimethanol diacrylate was used instead of the ethoxylated bisphenyl fluorene diacrylate.

### Synthesis Example 3: Synthesis of Compound Represented by Chemical Formula C

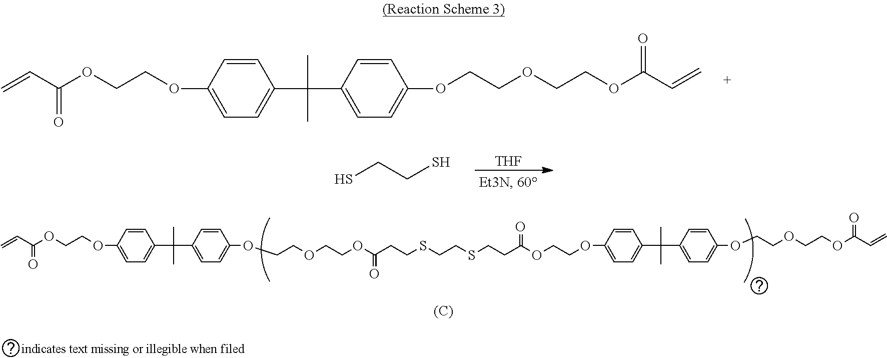

A compound represented by Chemical Formula (C) (Mw=1937) was obtained in the same manner as in Synthesis Example 1 except that 468 g of ethoxylated bisphenol A diacrylate was used instead of the ethoxylated bisphenyl fluorene diacrylate.

### Synthesis Example 4: Synthesis of Compound Represented by Chemical Formula D

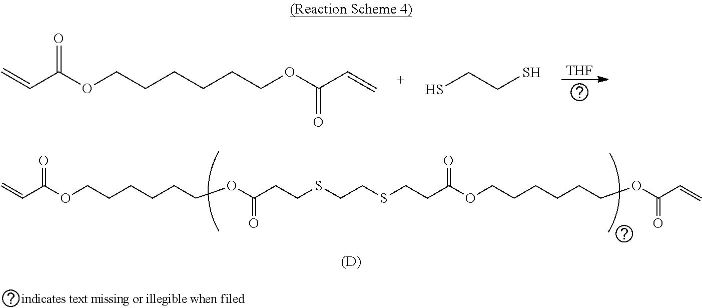

A compound represented by Chemical Formula (D) (Mw=1102) was obtained in the same manner as in Synthesis Example 1 except that 226 g of 1,6-hexanediol diacrylate was used instead of the ethoxylated bisphenyl fluorene diacrylate.

### (Preparation of Curable Compositions)

Based on each of the following components, curable compositions according to Examples 1 to 6 and Comparative Examples 1 and 2 were prepared.

### (A) Quantum Dots

(A-1) Green quantum dots (InP/ZnSe/ZnS, Hansol Chemical)
(A-2) Red quantum dots (InP/ZnSe/ZnS, Hansol Chemical)

### (B) Polymerizable Compound

(B-1) Compound represented by Chemical Formula 8-2 (M200, Miwon Chemical)

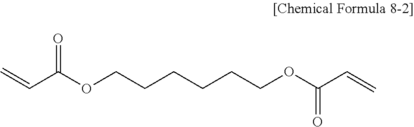 [SMILES: C=CC(=O)OCCCCCCOC(=O)C=C]

(B-2) Pentaerythritol hexamethacrylate (DPHA, Nippon Kayaku Co., Ltd.)
(B-3) Polymerizable compound of Synthesis Example 1
(B-4) Polymerizable compound of Synthesis Example 2
(B-5) Polymerizable compound of Synthesis Example 3
(B-6) Polymerizable compound of Synthesis Example 4
(B-7) Acryl-based binder resin (SM-CRB-400H, SMS Co., Ltd.)
(B-8) Polysilsesquioxane (Arakawa, SQ506)

### (C) Photopolymerization Initiator

TPO-L (Polynetron)

### (D) Light Diffusing Agent

Titanium dioxide dispersion (rutile type TiO₂; D50 (180 nm), solid content 50 wt %, Iridos Co., Ltd.)

### Examples 1 to 6 and Comparative Examples 1 and 2

Specifically, the quantum dots and polymerizable compound were mixed and then, stirred for 12 hours. Subsequently, a photopolymerization initiator was added thereto, and then, a light diffusing agent was added thereto.

Each specific composition was shown in Table 1.

TABLE 1
(unit: wt %)

| | | | | | | | | Comp. | Comp. |
|---|---|---|---|---|---|---|---|---|---|
| | | Ex. 1 | Ex. 2 | Ex. 3 | Ex. 4 | Ex. 5 | Ex. 6 | Ex. 1 | Ex. 2 |
| Quantum dots | (A-1) | 41 | 41 | 41 | 41 | — | — | 41 | — |
| | (A-2) | — | — | — | — | 36 | 36 | — | 36 |
| Polymerizable | (B-1) | 31.3 | 31.3 | 31.3 | 31.3 | 23.2 | 23.2 | 31.3 | 23.2 |
| compound | (B-2) | 4.0 | 4.0 | 4.0 | 4.0 | 4.0 | 4.0 | 4.0 | 4.0 |
| | (B-3) | 18.2 | — | — | — | 30.5 | — | — | — |
| | (B-4) | — | 18.2 | — | — | — | 30.5 | — | — |
| | (B-5) | — | — | 18.2 | — | — | — | — | — |
| | (B-6) | — | — | — | 18.2 | — | — | — | — |
| | (B-7) | — | — | — | — | — | — | 18.2 | — |
| | (B-8) | — | — | — | — | — | — | — | 30.5 |

| | | | | | | | | |
|---|---|---|---|---|---|---|---|---|
| Photopolymerization | 1.5 | 1.5 | 1.5 | 1.5 | 1.5 | 1.5 | 1.5 | 1.5 |
| initiator | | | | | | | | |
| Light diffusing agent | 4 | 4 | 4 | 4 | 4.8 | 4.8 | 4 | 4.8 |

### Evaluation

The curable compositions according to Examples 1 to 6 and Comparative Examples 1 and 2 were respectively taken by 2 mL and then, spin-. 4.4 coated on a glass substrate at 1,500 rpm, exposed with 5 J for 9 seconds by using a nitrogen UV exposer to form QD films, and then, the QD films were measured with respect to an initial blue light conversion rate by using a photoefficiency-measuring instrument (QE-2100, Otsuka Electronics Co., Ltd), and each substrate on which the QD films were formed was baked on a hot plate at 180° C. under a nitrogen atmosphere for 30 minutes and cooled to room temperature (23° C.) for 3 hours. Subsequently, the photoefficiency-measuring instrument was used to remeasure the blue light conversion rate to calculate a thermal process retention rate (%) according to the following equation.

Thermal process retention rate (%)=[light conversion rate(after baking)/initial light conversion rate]*100

In addition, the curable compositions were measured with respect to viscosity at 25° C. by using a viscometer (RV-2spins, 23 rpm, DV-II, Brookfield Engineering Laboratories, Inc.), and the results are shown in Table 2.

TABLE 2

| | Thermal process | |
|---|---|---|
| | retention rate (%) | Viscosity (cps) |
| Example 1 | 95 | 314 |
| Example 2 | 95 | 158 |
| Example 3 | 97 | 160 |
| Example 4 | 95 | 134 |
| Example 5 | 97 | 400 |
| Example 6 | 99 | 338 |
| Comparative Example 1 | 87 | 370 |
| Comparative Example 2 | 88 | 315 |

Referring to Table 2, the curable compositions according to Examples 1 to 6 were minimized from deterioration of a thermal process retention rate after the heat resistance process and thus exhibited an excellent thermal process retention rate (%), compared with the curable compositions according to Comparative Examples 1 and 2, and in addition, had no high viscosity and thus were smoothly ink-jetted even at room temperature.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims. Therefore, the aforementioned embodiments should be understood to be exemplary but not limiting the present invention in any way.

1. A curable composition, comprising
(A) quantum dots; and
(B) a polymerizable compound
wherein the polymerizable compound includes a product of a thiol-ene reaction between a (meth)acrylate-based monomer and a thiol-based monomer.

2. The curable composition of claim 1, wherein
the thiol-based monomer is a dithiol-based monomer.

3. The curable composition of claim 1, wherein
the thiol-based monomer is represented by Chemical Formula 1: 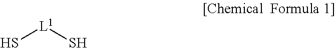
wherein, in Chemical Formula 1,
L¹ is an ether linking group (*—O—*), a sulfide linking group (*—S—*), a substituted or unsubstituted C1 to C20 alkylene group, a substituted or unsubstituted C3 to C20 cycloalkylene group, a substituted or unsubstituted C6 to C20 arylene group, or a combination thereof.

4. The curable composition of claim 3, wherein
Chemical Formula 1 is represented by Chemical Formula 1-1 or Chemical Formula 1-2: 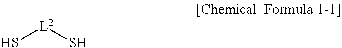
wherein, in Chemical Formula 1-1,
L² is a substituted or unsubstituted C1 to C20 alkylene group, 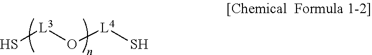
wherein, in Chemical Formula 1-2,
L³ and L⁴ are each independently a substituted or unsubstituted C1 to C20 alkylene group, and
n is an integer of 0 to 10.

5. The curable composition of claim 1, wherein
the (meth)acrylate-based monomer includes a monomer represented by Chemical Formula 2, a monomer represented by Chemical Formula 3, or a mixture thereof: 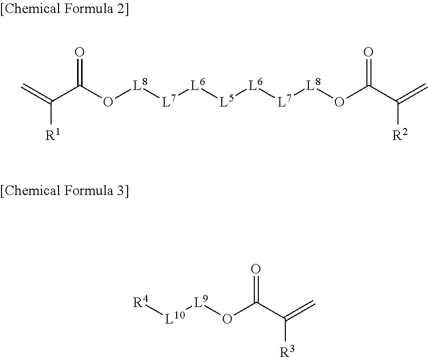
wherein, in Chemical Formula 2 and Chemical Formula 3,
R¹ to R⁴ are each independently a hydrogen atom, a substituted or unsubstituted C1 to C20 alkyl group or substituted or unsubstituted C6 to C20 aryl group, and
L⁵ to L¹⁰ are each independently a single bond, an ether linking group (*—O—*), a substituted or unsubstituted C1 to C20 alkylene group, a substituted or unsubstituted C6 to C20 arylene group, a substituted or unsubstituted C3 to C20 cycloalkylene group, a divalent fluorene linking group, or a divalent bicyclic linking group.

6. The curable composition of claim 5, wherein
the monomer represented by Chemical Formula 2 is represented by any one of Chemical Formula 2-1 to Chemical Formula 2-4: 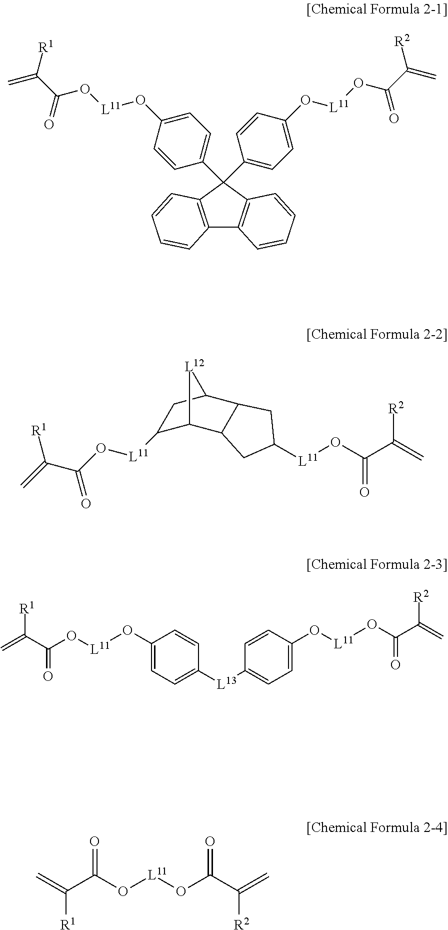
wherein, in Chemical Formula 2-1 to Chemical Formula 2-4,
R¹ and R² are each independently a hydrogen atom or a substituted or unsubstituted C1 to C20 alkyl group,
L¹¹ is a substituted or unsubstituted C1 to C20 alkylene group, and
L¹² and L¹³ are each independently an ether linking group (*—O—*) or a substituted or unsubstituted C1 to C20 alkylene group.

7. The curable composition of claim 5, wherein
in Chemical Formula 3, R³ is hydrogen atom or a substituted or unsubstituted C1 to C20 alkyl group, R⁴ is a substituted or unsubstituted C6 to C20 arylene group, and L⁹ and L¹⁰ are each independently an ether linking group (*—O—*) or a substituted or unsubstituted C1 to C20 alkylene group.

8. The curable composition of claim 1, wherein
the polymerizable compound includes at least one selected from a monomer represented by Chemical Formula 4 to a monomer represented by Chemical Formula 7: 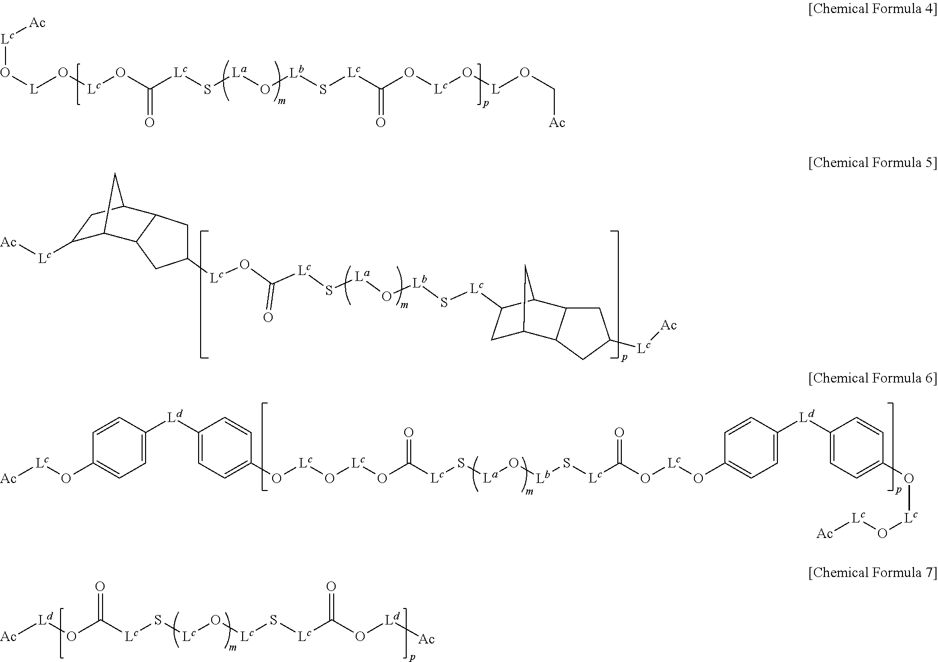
wherein, in Chemical Formula 4 to Chemical Formula 7,
Ac is a (meth)acrylate group,
L^{a} to L^{d} are each independently a substituted or unsubstituted C1 to C20 alkylene group,
R^{a} is a substituted or unsubstituted C1 to C20 alkyl group or a substituted or unsubstituted C6 to C20 aryl group,
m is an integer of 0 to 10,
p is an integer of 1 to 100, and
q is an integer of 0 to 5.

9. The curable composition of claim 1, wherein
the polymerizable compound further includes a monomer represented by Chemical Formula 8 in addition to the product of the thiol-ene reaction between the (meth)acrylate-based monomer and the thiol-based monomer: 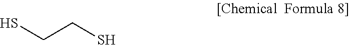
wherein, in Chemical Formula 8,
R⁵ and R⁶ are each independently a hydrogen atom or a substituted or unsubstituted C1 to C10 alkyl group,
L¹⁴ and L¹⁶ are each independently a single bond or a substituted or unsubstituted C1 to C10 alkylene group, and
L¹⁵ is a substituted or unsubstituted C1 to C10 alkylene group, a substituted or unsubstituted C3 to C20 cycloalkylene group, or an ether linking group (*—O—*).

10. The curable composition of claim 9, wherein
the monomer represented by Chemical Formula 8 is included in an amount greater than the product of the thiol-ene reaction between the (meth)acrylate-based monomer and the thiol-based monomer.

11. The curable composition of claim 1, wherein
the curable composition has a viscosity of 500 cps to 1100 cps.

12. The curable composition of claim 1, wherein
the curable composition is a solvent-free curable composition.

13. The curable composition of claim 12, wherein
the solvent-free curable composition includes, based on the total amount of the solvent-free curable composition,
5 wt % to 60 wt % of the quantum dots; and
40 wt % to 95 wt % of the polymerizable compound.

14. The curable composition of claim 1, wherein
the curable composition further includes a polymerization initiator, a light diffusing agent, a polymerization inhibitor, or a combination thereof.

15. The curable composition of claim 14, wherein
the light diffusing agent includes barium sulfate, calcium carbonate, titanium dioxide, zirconia, or a combination thereof.

16. The curable composition of claim 1, wherein
the curable composition further includes a solvent.

17. The curable composition of claim 16, wherein
the curable composition includes 1 wt % to 40 wt % of the quantum dots; 1 wt % to 20 wt % of the polymerizable compound; and 40 wt % to 80 wt % of the solvent based on the total amount of the curable composition.

18. The curable composition of claim 1, wherein
the curable composition further includes malonic acid; 3-amino-1,2-propanediol; a silane-based coupling agent; a leveling agent; a fluorine-based surfactant; or a combination thereof.

19. A cured layer manufactured using the curable composition of any one of claim 1 to claim 18.

20. A color filter comprising the cured layer of claim 19.

21. A display device comprising the color filter of claim 20.
